(19) United States
(12) Patent Application Publication
(10) Pub. No.: US 2017/0212357 A1
(43) Pub. Date: Jul. 27, 2017

(54) MINIMUM FLOOR SPACE COMMERCIAL AIR FILTER

(71) Applicant: RoboVent Products Group, Inc., Sterling Heights, MI (US)

(72) Inventors: John Reid, Royal Oak, MI (US); James Reid, Blacklick, OH (US); Michael Hattingh, Troy, MI (US)

(21) Appl. No.: 15/381,482

(22) Filed: Dec. 16, 2016

Related U.S. Application Data
(60) Provisional application No. 62/268,083, filed on Dec. 16, 2015.

(51) Int. Cl. G02B 27/14; G01N 21/64; G02B 21/08; G02B 21/24; G02B 21/00

(52) U.S. Cl. CPC G02B 27/141; G02B 21/245; G02B 21/0032; G02B 21/082; G02B 21/0004; G01N 21/6458

(57) ABSTRACT

A minimum floor space air filter unit has an outer housing defined by side walls which has a height that is substantially larger than the base. A blower is mounted in the base. An elongated filter column is mounted in the housing. The blower is positioned below the elongated filter column to draw air with entrained particulate into an air inlet and through the elongated filter column for exiting the housing through an air outlet. Entrained particulate is captured on the exterior surface of the elongated filter column. At least one nozzle is positioned within the interior core of the elongated filter column to pulse air from the interior through the elongate filter media column to remove entrained particulate from the exterior surface.

### RELATED APPLICATIONS

This application claims the benefit of U.S. Provisional Patent Application Ser. No. 62/268,083, filed Dec. 16, 2015, the entire disclosure of the application being considered part of the disclosure of this application and hereby incorporated by reference.

### STATEMENT REGARDING FEDERALLY SPONSORED RESEARCH

NONE.

### TECHNICAL FIELD

This invention relates generally to industrial air filtering systems and more specifically to an air filtering system that requires minimum floor space for use in operations that create airborne contaminants such as for example, welding fumes, grinding dust, etc.

### BACKGROUND OF THE INVENTION

Air filtering systems are well known throughout several industries where maintaining a clean environment is critical. For example, in vehicle manufacturing, welding processes are necessary for welding steel frames for vehicles. Typically, such welding processes are carried out in a welding chamber wherein dust particulates are generated and infiltrate the air. Often, such welding processes are conducted by robotically controlled equipment.

Generally, the air filtering system resides on the floor of a manufacturing facility in close proximity to the area to be filtered and occupies a significant amount of floor space in the plant, or is mounted outside of the facility. If it is mounted in the plant, it occupies valuable floor space. If it is mounted outside the facility, the system is connected to the work area by large air ducts through which dust-laden air travels. Thus, relocating the air filtering system about the facility requires the air ducts to be re-routed.

These air filtering systems have several disadvantages. First, they are generally substantial in size in order to accommodate industrial applications. Consequently, they occupy large amounts of floor space in and around the manufacturing facility or require a significant amount of air ducts with complex routing. Both systems result in increased costs and particularly in the case of the ducts, make relocation difficult, time-consuming and costly. In addition, dust from the air traveling through the ducts accumulates on the walls of the ducts, which can become heavy and create maintenance problems with the ducts.

The present invention is aimed at solving one or more of the problems described above.

### BRIEF DESCRIPTION OF THE DRAWINGS

FIG. 1 is an exploded perspective view of the minimum floor space commercial air filter of the present invention.

FIG. 2 is a perspective view of the view of the minimum floor space commercial air filter of the present invention.

FIG. 3 is a partial perspective view of the top and middle compartments of the minimum floor space commercial air filter of the present invention.

FIG. 4 is a partial perspective view of the top and middle compartments with enlarged views of the minimum floor space commercial air filter of the present invention.

FIG. 5 is a perspective view and enlarged view of the minimum floor space commercial air filter of the present invention.

FIG. 6 is a perspective view of the minimum floor space commercial air filter of the present invention.

FIG. 7 is a partial cutaway view of the motor compartment of the minimum floor space commercial air filter of the present invention.

FIG. 8 is a perspective view and enlarged view of the minimum floor space commercial air filter of the present invention.

### DETAILED DESCRIPTION OF A PREFERRED EMBODIMENT

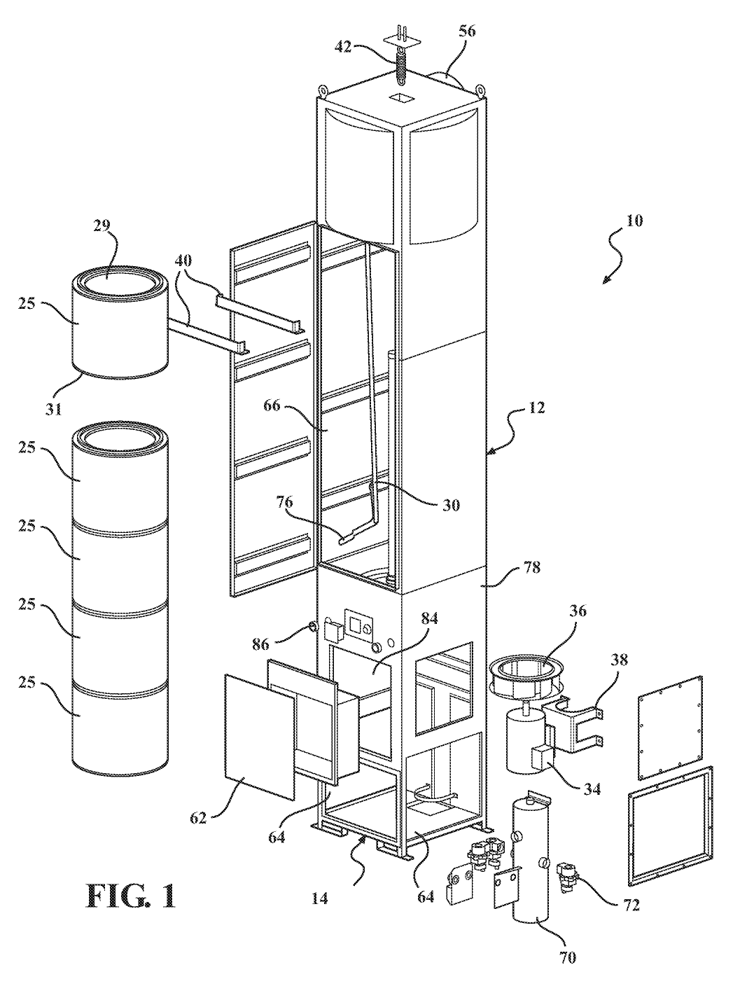

The minimum floor space air filter of the present invention is generally shown at 10 in FIG. 1. The air filter 10 of the present invention has a base of approximately 30 inches and a height of approximately 196 inches for a height to base ratio of approximately 6.5 to 1. The base of approximately 30 inches takes up a minimum of floor space which is important in factories, as floor space is very valuable. The lower floor space that is used the less overall floor space is required which reduces overall costs. Additionally, with less floor space, additional units can be used increasing overall production with no additional floor space.

It is important to understand that reducing the floor space still requires that the same amount of filter area be provided to filter the contaminants of the air entering the filter unit. Additionally, the reduced floor space requires the overall height be within certain pre-determined parameters to fit within the height requirements of typical work areas. The challenge is meeting the filter area requirements, height requirements while still maintaining minimum floor requirements.

The present invention has an outer housing 12 with a base 14 and side walls 16. The base 14 of the disclosed embodiment is generally square with a width and length of approximately 30 inches. It should be understood that the invention is not limited to a square base 14. The base could be any geometric shape, such as a rectangle, circle, oval, hexagon, etc. The side walls 16 have a height of approximately 196 inches and a width of approximately 30 inches. As with the base 14, the side walls 16 could have curves, etc. and may or may not have the general shape of the base 14. For example, the side walls 16 could form a general rectangle, while the base 14 could be hexagonal, etc.

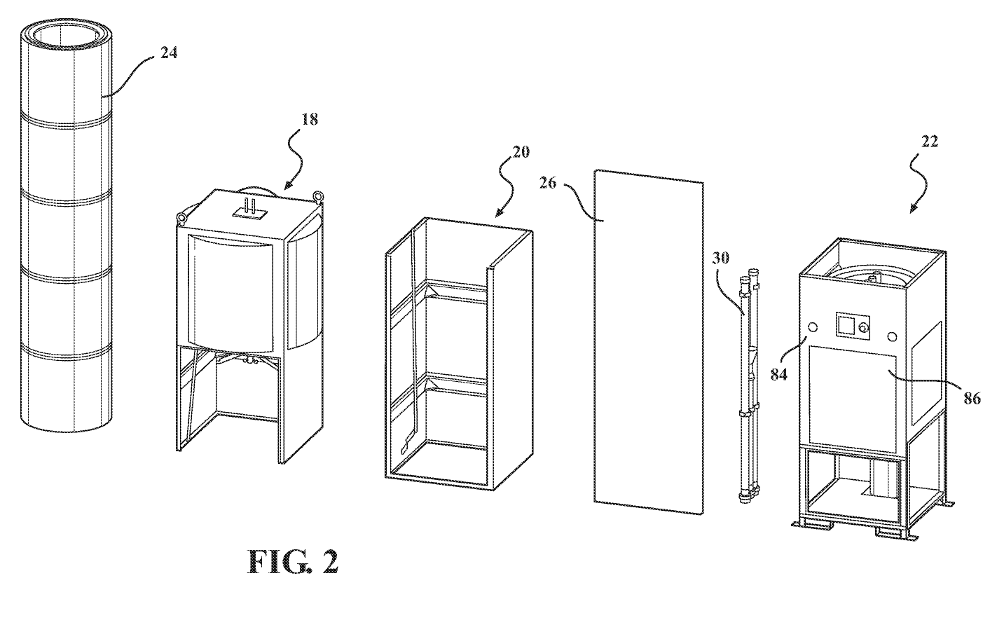

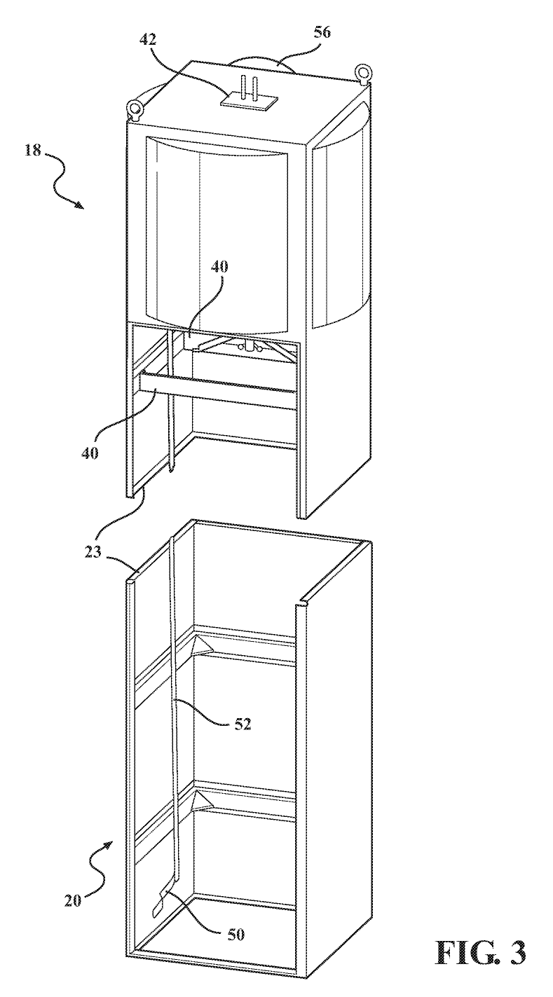

With reference to FIG. 2, the filter unit 10 of the preferred embodiment has three (3) sections, a top compartment 18, a middle compartment 20 and a motor compartment 22. These three compartments are assembled to form the filter unit 10. With reference to FIG. 3, the compartments of the disclosed embodiment have a lip 23 that is positioned on the adjoining compartment to allow easy assembly. In the disclosed embodiment, the lips receive fasteners to fasten the compartments to one another. Sealant is used to fill any gaps between the joined compartments to form an air tight seal.

An elongated filter column 24 is housed within the middle compartment 20. In the disclosed embodiment, the column 24 is disclosed as having 5 separate filters stacked upon each other. It should be appreciated that more or fewer filters could be used. For example, the filters can be less than five, for example 3 stacked filters as opposed to 5, or two, even 1, and can be more than 5. However, having 3 filters makes replacing the filters cumbersome due to the size of the filters. It has been found that 5 filters are less cumbersome to manipulate when being replaced.

The use of more than one filter requires that the individual filters 25 which combine to form the elongated filter column 24 have the necessary filter media surface area to properly filter the air. If for example five individual filters 25 are used, then each filter 25 must have at least one fifth (⅕) the required filter media area. Each filter 25 of the disclosed embodiment has a body portion 27 which includes the filter media surface area. Each filter 25 also has an upper ring 29 and a lower ring 31. The rings 29 and 31 support the filters 25 when they are stacked and facilitate sealing of the filters 25 with respect to one another when stacked.

It should be appreciated that stacking the filters 24 in a column as opposed to placing the filters side by side is a very cost effective design. By stacking the filters 24 in a column, the need for a traditional plenum is eliminated. Traditional air filter units have a number of filters sitting in one or more rows with the filters placed side by side. This requires that each filter be in operative communication with a plenum. The plenum is connected to the blower which pulls air through the air filters via the plenum. Each of the filters requires seals and retainers to join the filters to the plenum. Plenums also have high maintenance requirements, since inevitably there is an accumulation of particulates in the plenum which routinely needs to be cleaned. The present invention eliminates the need for the plenum and the resultant savings in reduced sheet metal, fabrication, seals, retainers, and maintenance. The stacking of the filters also provides for the ability to have a very small footprint and the resultant savings from such a small footprint.

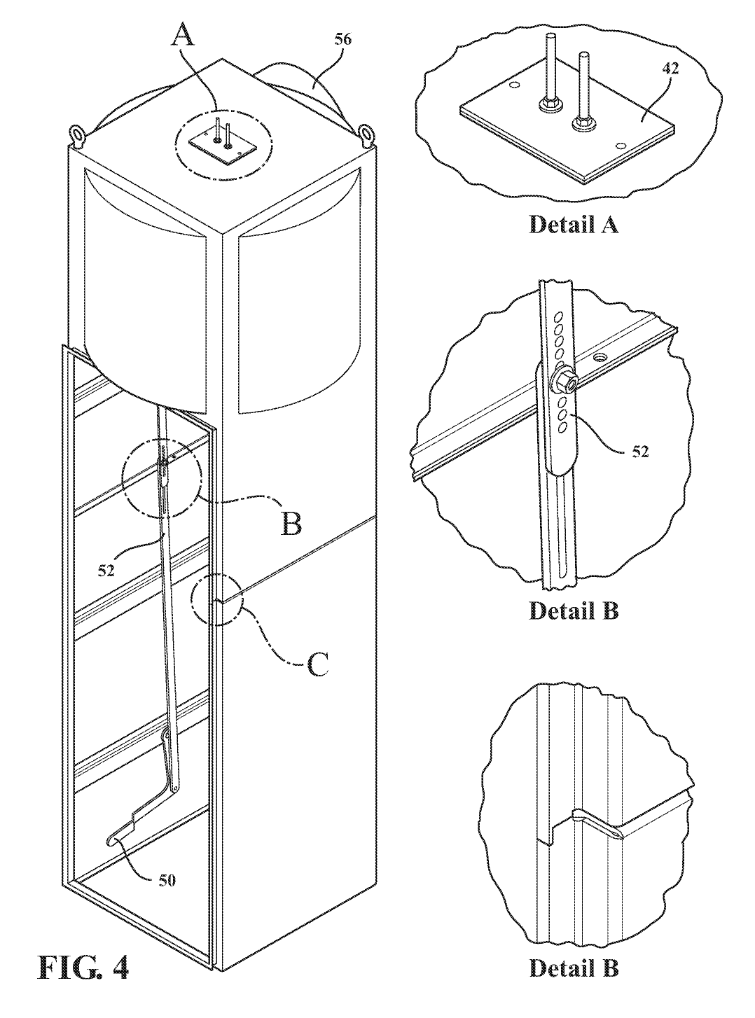

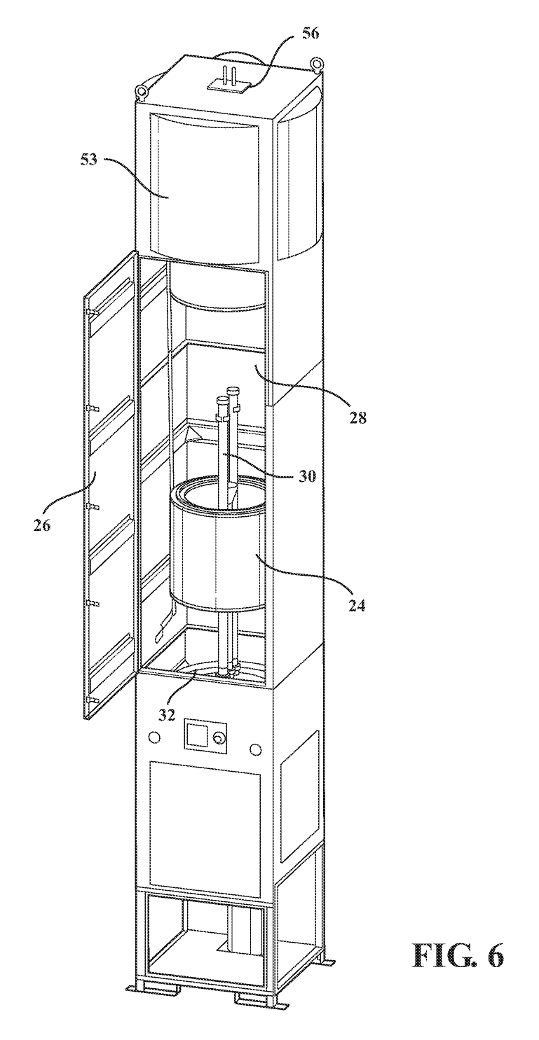

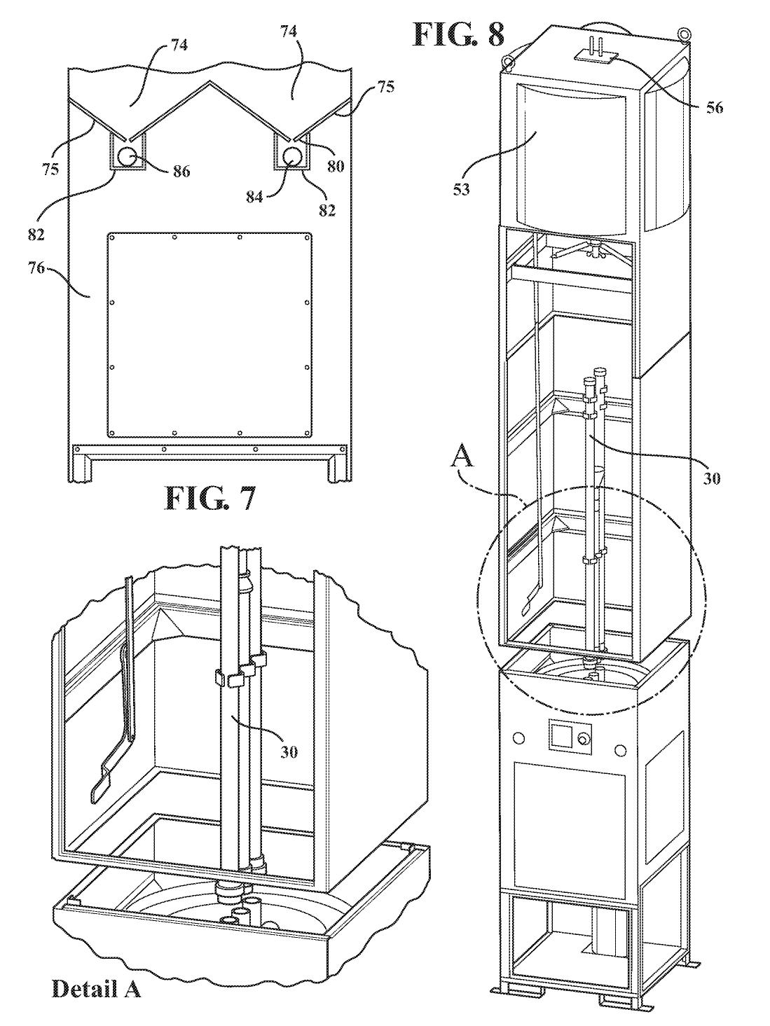

With reference to FIGS. 1, 3, 4, 5 and 6, the installation of the filters 24 into the air filter unit 10 will be described. With reference to FIG. 6, the housing 12 has a door 26 for closing the filter compartment 28. The door 26 is sealed and in the disclosed embodiment latches, such as t-handles, knobs, screws etc., are used to latch the door 26 in sealing closure with the housing 12. A lower filter 24 is positioned in the filter compartment and dropped down over the pulse pipes 30. The pulse pipes 30 will be described in greater detail below. The first or lowermost filter 24 seats on a lower mounting seal or ring 32 that is just above the blower 33 includes a blower motor 34 and blower wheel 36. In the disclosed embodiment, the blower motor 34 is connected to the housing 12 through a baseplate 38.

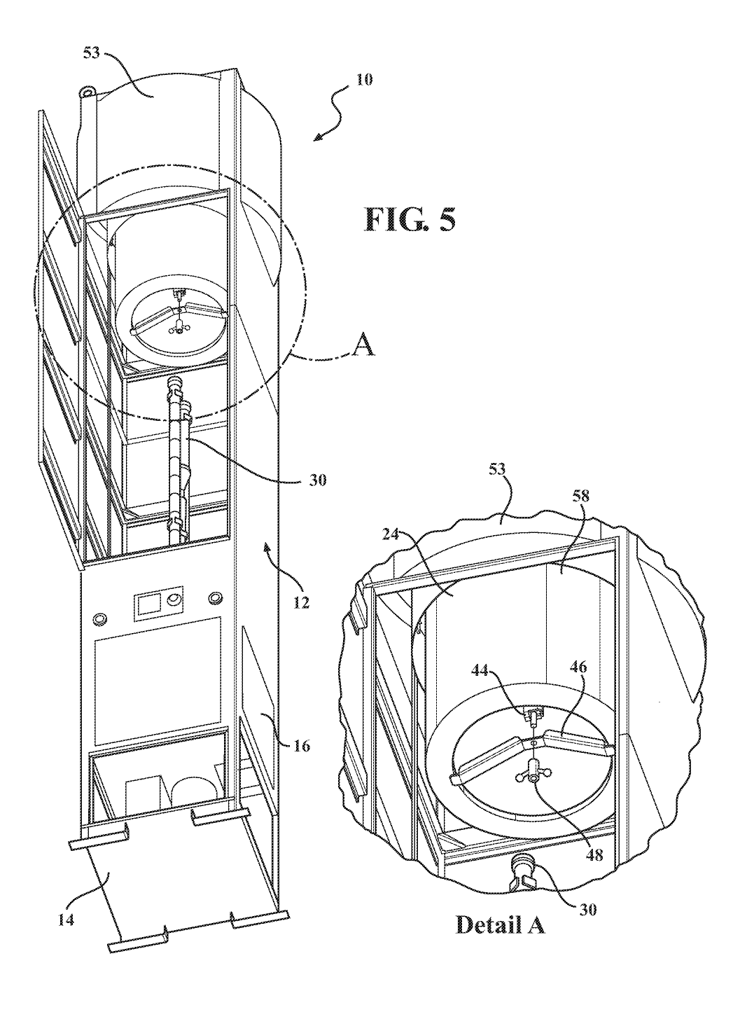

A top filter 24 is positioned on the lift bars 40 to hold that filter in the top of the housing 12. A top filter mount tension spring 42 connects to a rod 44 that extends down through the filter 24 and connects to a retaining bar 46 and a tee handle 48, see FIG. 5. The retaining bar 46 engages the bottom of the top filter 24 to allow the filter to be raised with respect to the remaining stack of filters 24. In operation, the top filter 24 is positioned on the lift bars 40. The spring 42 and rod 44 are connected to a lever 50 and connecting arms 52. The lever 50 is raised, which extends the rod 44 past the bottom of the filter 24. This allows the retaining bar 46 and tee handle 48 to be connected to the rod 44. The lever 50 is then lowered which results in the filter 24 being supported on the retaining bar 46 and raised. This allows space to be provided for the remaining three (3) filters to be inserted between the top and bottom filters 24. Once all the filters are in the filter compartment, the lever 50 is raised, dropping the top filter 24 back onto the stack of filters 24.

To remove the filters 24 for replacement, the lever is lowered, which raises the top filter 24 which is supported on the retaining bar 46. The bottom four filters 24 are removed, then the lift bars are positioned under the top filter 24 and the lever 50 is raised to lower the filter 24 onto the lift bars. The t-handle 48 and retainer bar 46 are removed and the top filter 24 can then be removed from the filter compartment 28.

The spark arrestor 53 initially receives the air from the work area through the air inlet 56. In the disclosed embodiment, the spark arrestor 53 is a Delta 3 Spark Out brand spark arrestor manufactured and sold by applicant. Since these units 10 are commonly used in connection with the filtering of air from welding operations, there can be sparks entrained in the air. The spark arrestor 53 captures these sparks so that they do not reach the filter media 24.

The motor compartment 22 contains the motor 34 and blower 36. A control panel 62 controls the motor 34. The blower 36 is positioned to draw air through the filters 24. In the disclosed embodiment, a venturi inlet (not shown) is mounted between the bottom of the lower filter 24 and the top of the blower wheel to increase air velocity. In operation, the motor is energized and the blower 36 draws air through the filters 24 from the air inlet 56. This air is first drawn through the spark arrestor 53 and then around, down and through the outside of the filters 24. Particulates in the air are captured by the filters and the filtered air is then exhausted through an air outlet or exhaust openings 64 at the bottom of the housing 12.

As will be appreciated, overtime, the filters will begin to collect dust and particulate that will eventually adversely affect performance. To extend the useful life of the filters, the filters are cleaned periodically within the unit 10. To clean the filters, a reverse pulse system is used. The reverse pulse system uses one or more pulse nozzles or cones 64 mounted upon the ends of one or more pulse pipes 30, which are in turn connected to a compressed air header 70. Typically, the compressed air supply is provided within the work environment housing the air filter unit 10. A compressed air connection is provided to operatively connect the header 70 to the compressed air supply.

The header 70 has valves 72, which in the disclosed embodiment are solenoid operated valves, that when opened, pulse compressed air from the header 72 through the pipes 30 and out the nozzles 64. The valves 72 are controlled by the control panel 62. This pulsing of compressed air blows contaminants from the outside of the filters 24 for collection in the collection troughs 74 shown in FIG. 10.

With reference to FIG. 10, the clean out function of the present invention will be described. An accumulation of contaminants is illustrated having been received within the collection trough 74. The collection trough 74 is defined by the interior floor 75 of the filter compartment 28 which is at the upper portion of the motor compartment 22.

In the disclosed embodiment, the collection trough 74 extends the front panel 76 to the rear panel 78 of the motor compartment 22. A suction gap 80 is created in the interior floor 75. This gap extends the length of the collection trough 74. The gap 80 is in fluid communication with a suction chamber 82 which is in turn in fluid communication with the cleanout ports 84 and 86. In operation, a suction device, such as a shop vacuum with a hose and nozzle attachment can be inserted in to the ports 84 and 86 to create a vacuum within the suction chamber 82. This in turn creates a large vacuum at the very small gaps 80 to then suck the contaminants within the collection trough 74 through the gap 80 and out the ports 84 and 86 respectively.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A minimum floor space air filter unit comprising:
an outer housing defined by side walls, said side walls having a height and a base, said base having a width, said sidewall height being substantially greater than said base width; said housing including an air inlet and an air outlet;
a blower mounted in said base,
at least two elongated filters mounted within said housing, said elongated filters having filter media defining an interior core, said filter media having an exterior surface, said filters being stacked to define an elongated filter column;
said blower being positioned below said filters to draw air with entrained particulate into said air inlet and through said elongated filter column for exiting said housing through said air outlet, said entrained particulate being captured on said exterior surface of said elongated filters;
at least one nozzle positioned within said interior core of said filter media to pulse air from said interior core through said filter media to remove entrained particulate from said exterior surface.

2. The minimum floor space air filter unit of claim 1, wherein said housing has three compartments, a top compartment, a middle compartment and a motor compartment, said blower is mounted within said motor compartment, said elongated filters are mounted within said middle compartment;
said minimum floor space air filter further including a spark arrestor mounted in said top compartment.

3. The minimum floor space filter unit of claim 1, further including a lifting mechanism for lifting one of said filters to allow insertion of said at least one other filter into said housing.

4. The minimum floor space filter unit of claim 1, further including a lifting mechanism for lifting one of said filters to allow insertion of said at least one other filter into said housing;
said lifting mechanism includes a tension spring and a rod, said tension spring is connected to said rod, said rod extends down into one of said at least two elongated filters;
a retaining bar engages the bottom of said one said at least two elongated filters to allow said filter to be raised;
whereby said rod is initially extended beyond the bottom of said one of said at least two elongated filters allowing said retaining bar to be connected to said rod such that said one of said at least two elongated filters is supported on said retaining bar and raised.

5. The minimum floor space filter of claim 4, further including a lever connected to said rod to facilitate raising and lowering of said rod.

6. The minimum floor space filter unit of claim 1, further including a collection trough and a suction gap said suction gap extends the length of said collection trough; a suction chamber, said suction gap is in fluid communication with said suction chamber; and
clean out ports in fluid communication with said suction chamber;
wherein a suction device can be inserted into said ports to create a vacuum within said suction chamber which creates a large vacuum at said suction gaps to suck the contaminants within the collection trough through the gap and out the ports.

7. The minimum floor space filter unit of claim 1, wherein said height is at least 6 times said width.

8. The minimum floor space filter unit of claim 1, further including three nozzles placed at different heights within said interior core of said filter media to pulse air from said interior core through said media to remove entrained particulate from said exterior surface.

9. A minimum floor space air filter unit comprising:
an outer housing defined by side walls having a height and a base having a width, said sidewall height being substantially greater than said base width, said housing including an air inlet and an air outlet;
a blower mounted in said base,
an elongated filter column mounted within said housing, said elongated filter column having filter media defining an interior core, said filter media having an exterior surface;
said blower being positioned below said elongated filter column to draw air with entrained particulate into said air inlet and through said elongated filter column for exiting said housing through said air outlet, said entrained particulate being captured on said exterior surface of said elongated filter column;
at least one nozzle positioned within said interior core of said elongated filter column to pulse air from said interior through said elongate filter media column to remove entrained particulate from said exterior surface.

10. The minimum floor space air filter unit of claim 9, wherein said housing has three compartments, a top compartment, a middle compartment and a motor compartment, said blower is mounted within said motor compartment, said elongated filter column is mounted within said middle compartment;
said minimum floor space air filter further including a spark arrestor mounted in said top compartment.

11. The minimum floor space filter unit of claim 9, further including a lifting mechanism for lifting one of said filters to allow insertion of said at least one other filter into said housing.

12. The minimum floor space filter unit of claim 9, further including a collection trough and a suction gap said suction gap extends the length of said collection trough; a suction chamber, said suction gap is in fluid communication with said suction chamber; and
clean out ports in fluid communication with said suction chamber;
wherein a suction device can be inserted into said ports to create a vacuum within said suction chamber which creates a large vacuum at said suction gaps to suck the contaminants within the collection trough through the gap and out the ports.

13. The minimum floor space filter unit of claim 9, wherein said height is at least 6 times said width.

14. The minimum floor space filter unit of claim 9, further including three nozzles placed at different heights within said interior core of said filter media to pulse air from said interior core through said media to remove entrained particulate from said exterior surface.

15. A minimum floor space air filter unit comprising:
an outer housing defined by side walls having a height and a base having a width, said sidewall height being substantially greater than said base width, said housing including an air inlet and an air outlet;
a blower mounted in said base,
said outer housing defining an elongated filter compartment for receipt of one or more elongated filters;
said blower being positioned below said filter compartment to draw air with entrained particulate into said elongated filter compartment from said air inlet for exiting said housing through said air outlet;
at least one nozzle positioned within said filter compartment to pulse air into said compartment.

16. The minimum floor space air filter unit of claim 15, wherein said housing has three compartments, a top compartment, a middle compartment and a motor compartment, said blower is mounted within said motor compartment, said elongated filter column is adapted to be mounted within said middle compartment;
said minimum floor space air filter further including a spark arrestor mounted in said top compartment.

17. The minimum floor space filter unit of claim 15, further including a collection trough and a suction gap said suction gap extends the length of said collection trough; a suction chamber, said suction gap is in fluid communication with said suction chamber; and
clean out ports in fluid communication with said suction chamber;
wherein a suction device can be inserted into said ports to create a vacuum within said suction chamber which creates a large vacuum at said suction gaps to suck the contaminants within the collection trough through the gap and out the ports.

18. The minimum floor space filter unit of claim 15, wherein said height is at least 6 times said width.

19. The minimum floor space filter unit of claim 15, further including three nozzles placed at different heights within said interior core of said filter media to pulse air from said interior core through said media to remove entrained particulate from said exterior surface.

20. A filter module for use in a minimum floor space air filter unit having a vertical elongated housing, said filter module comprising:
a generally tubular body portion defining an exterior surface and a core, said tubular body portion having a top ring and bottom ring,
said top ring and bottom ring being adapted to support an adjacent stacked filter module;
said filter module being adapted for insertion into the vertical elongated housing;
said filter module having a filtering capacity that is less than the overall filtering capacity of the minimum floor space air filter, wherein stacking of said filter modules is required to obtain the desired filtering capacity.
